(19) United States
(12) Patent Application Publication
(10) Pub. No.: US 2005/0088986 A1
(43) Pub. Date: Apr. 28, 2005

(54) Systems and methods for distributing data

(76) Inventors: Feng-Wen Sun, Germantown, MD (US); Stan Kay, Rockville, MD (US)

Correspondence Address: THE DIRECTV GROUP, INC., RE/R11/A109, P.O. Box 956, El Segundo, CA, 90245-0956, US

(21) Appl. No.: 10/821,300

(22) Filed: Apr. 9, 2004

Related U.S. Application Data
(60) Provisional application No. 60/514,684, filed on Oct. 27, 2003.

(51) Int. Cl. H04B 7/216

(52) U.S. Cl. 370/316

(57) ABSTRACT

A system for transmitting data packets over an air interface includes logic for generating a number of redundant packets and parity information. The data packets, redundant packets and parity information may then be transmitted to a distribution device that provides error correction codes. The distribution device may then transmit the data to one or more destinations over an air interface.

### RELATED APPLICATIONS

This application claims priority under 35 U.S.C. § 119 based on U.S. Provisional Application Ser. No. 60/514,684, filed Oct. 27, 2003, the entirety of which is incorporated herein by reference.

### BACKGROUND OF THE INVENTION

1. Field of the Invention

The present invention relates generally to data communications and, more particularly, to data distribution.

2. Description of Related Art

In conventional satellite communication systems, a signal from one ground station may be relayed via satellite to another ground station. In such systems, the satellite may act as a transponder and merely relay the received signal to its destination. In an onboard switching satellite system, onboard processing systems at the satellite receive a signal (i.e., an uplink signal) from one ground station and demodulate/decode the uplink signal. The decoded data is then re-encoded, re-modulated and transmitted via a downlink signal to the destination ground station(s).

One limiting factor associated with onboard switching satellite systems is that once the satellite is launched, it is very difficult (if not impossible) to change the coding and modulation schemes used by onboard systems. Another drawback with conventional onboard switching satellite systems is that the communication link from the satellite to the ground stations may be designed to use a nominal beam size. For certain types of data, such as data transmissions to be broadcast over a relatively large area, the power density of the downlink signal may be reduced since the beam size may be much larger than the nominal beam size. This may result in a relatively weak downlink signal and may lead to increased errors at the destination ground stations.

For certain types of data transmission, such as video data transmissions, a higher quality associated with the received data may be required at the destination ground stations. In these cases, a lower packet error rate may be required for the downlink data so that an end user is able to use (e.g., view) the downlink data in a satisfactory manner. Such lower packet error rates may not be achievable using conventional systems.

### SUMMARY OF THE INVENTION

In accordance with the principles of the invention as embodied and broadly described herein, a system that includes a first coder, a second coder and logic is provided. The first coder is configured to receive at least one first data stream and generate a number of packets based on the received first data stream, where the plurality of data packets represent redundant data packets. The second coder is configured to receive the first data stream and the redundant data packets and generate parity information for the received first data stream and the redundant data packets. The second coder is also configured to output a second data stream including the first data stream, the redundant packets and the parity information. The logic is configured to modulate the second data stream and forward the modulated data.

In accordance with another implementation consistent with the invention, a device for processing data that includes a receiver, a demodulator, a first decoder, a second decoder and a third decoder is provided. The receiver is configured to receive video data, where the video data includes a payload portion including parity information and a redundant data portion. The demodulator is coupled to the receiver and is configured to demodulate the received video data. The first decoder is configured to decode the received data using a soft decoding process and the second decoder is configured to determine whether the payload portion contains an error. The third decoder is configured to perform an error recovery procedure on the payload portion when the second decoder indicates that the payload portion contains an error.

According to a further implementation consistent with the invention, a method for distributing data via radio frequency (RF) signals is provided. The method includes receiving a number of data packets and generating parity information for each of the data packets. The method also includes generating a number of redundant packets based on the received data packets and forwarding the data packets, the parity information and the redundant data packets to a distribution device via RF signals.

According to still another implementation consistent with the invention, a device for decoding data includes a receiver that receives a data stream. The device also includes a number of registers, where each register corresponds to a surviving path associated with a number of trellis states. The device further includes logic configured to reset contents of the registers to zero at a beginning of a boundary. The logic is also configured to update the contents of the registers based on a parity of the surviving path and eliminate the surviving path with odd accumulated parity at an end of the boundary.

### BRIEF DESCRIPTION OF THE DRAWINGS

The accompanying drawings, which are incorporated in and constitute a part of this specification, illustrate the invention and, together with the description, explain the invention. In the drawings,

FIG. 1 is a diagram of an exemplary network in which methods, devices and systems consistent with the invention may be implemented;

FIG. 2 is a diagram of an exemplary configuration of the hub and terminal of FIG. 1 in an implementation consistent with the invention;

FIG. 3 is a functional block diagram of an exemplary onboard processing system implemented in the satellite of FIG. 1 in an implementation consistent with the invention;

FIG. 4 is a block diagram of an exemplary system implemented at the hub of FIG. 1 in an implementation consistent with the invention;

FIG. 5 is an exemplary block diagram illustrating a portion of the outer code enhancing coder of FIG. 4 in an implementation consistent with the invention;

FIGS. 6A and 6B are exemplary block diagrams further illustrating portions of the outer code enhancing coder of FIG. 5 in an implementation consistent with the invention;

FIG. 7 is an exemplary flow diagram illustrating processing associated with transmitting uplink data in an implementation consistent with the invention;

FIG. 8 is a block diagram of an exemplary system implemented at the terminal of FIG. 1 in an implementation consistent with the present invention;

FIG. 9 is an exemplary block diagram illustrating processing performed by the Viterbi decoder of FIG. 8 in an implementation consistent with the invention;

FIG. 10 is an exemplary flow diagram illustrating processing associated with processing downlink data in an implementation consistent with the invention; and

FIG. 11 is an exemplary block diagram illustrating a portion of the system of FIG. 8 in an implementation consistent with the invention.

### DETAILED DESCRIPTION

The following detailed description of the invention refers to the accompanying drawings. The same reference numbers in different drawings may identify the same or similar elements. Also, the following detailed description does not limit the invention. Instead, the scope of the invention is defined by the appended claims and equivalents.

Exemplary Network

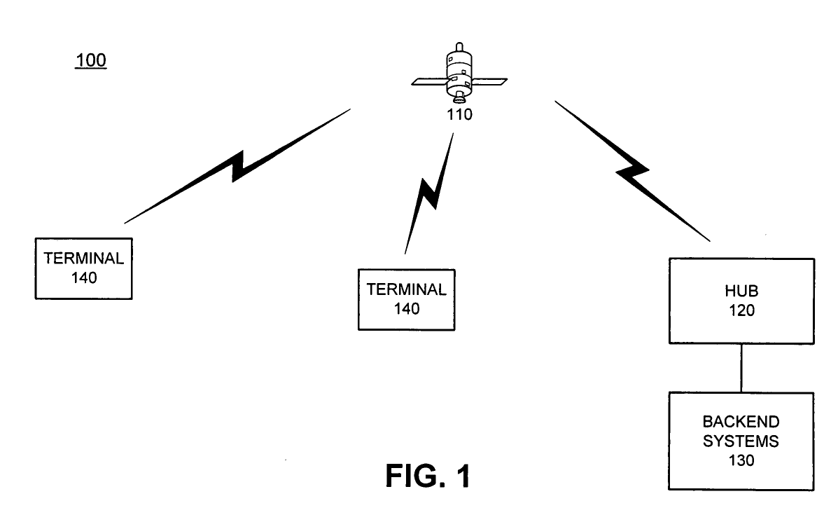

FIG. 1 illustrates an exemplary network in which methods, devices and systems consistent with the present invention may be implemented. Network 100 includes a satellite 110, a hub 120, backend systems 130 and a number of terminals 140. The number of components illustrated in FIG. 1 is provided for simplicity. It will be appreciated that a typical network 100 may include more or fewer components than are illustrated in FIG. 1.

Satellite 110 may support two-way communications with earth-based stations, such as hub 120 and terminals 140. Satellite 110 may include one or more uplink antennas and one or more downlink antennas for receiving data from and transmitting data to earth-based stations. Satellite 110 may also include transmit circuitry and receive circuitry to permit satellite 110 to use the downlink antenna(s) and uplink antenna(s) to transmit and receive data using various ranges of frequencies. Satellite 110 may further include onboard systems for decoding uplink data and re-encoding the data for transmission via downlink signals, as described in more detail below.

Hub 120 may broadcast data to a large number of terminals 140 via satellite 110. For example, hub 120 may encode and modulate television programming for broadcast to terminals 140 via satellite 110. Hub 120 may also interface with a network operations center (not shown) that manages network 100, including hub 120. For example, the network operations center may determine the appropriate power levels associated with transmitting data to/from satellite 110. The network operations center may then transmit, via hub 120, uplink information to satellite 110 regarding downlink power control.

Backend systems 130 may provide the interface between network 100 and an external network/system. For example, backend systems 130 may receive television programming from a broadcast entity. Backend systems 130 may also include routers, firewalls, domain name servers (DNSs), etc., for connection to an external public network, e.g., the Internet.

Terminals 140 transmit and receive information over an air/free space interface to/from satellite 110. Terminals 140 may interface with user devices, such as set top boxes for distributing television signals to one or more televisions, personal computers (PCs), lap top computers, personal digital assistants (PDAs), wireless telephones, etc., to provide users with television programming, broadband IP communication services, etc. Terminals 140 may also connect to user devices via a local area network (LAN) interface. In one implementation, terminals 140 receive television broadcasting transmitted from hub 120 via satellite 110.

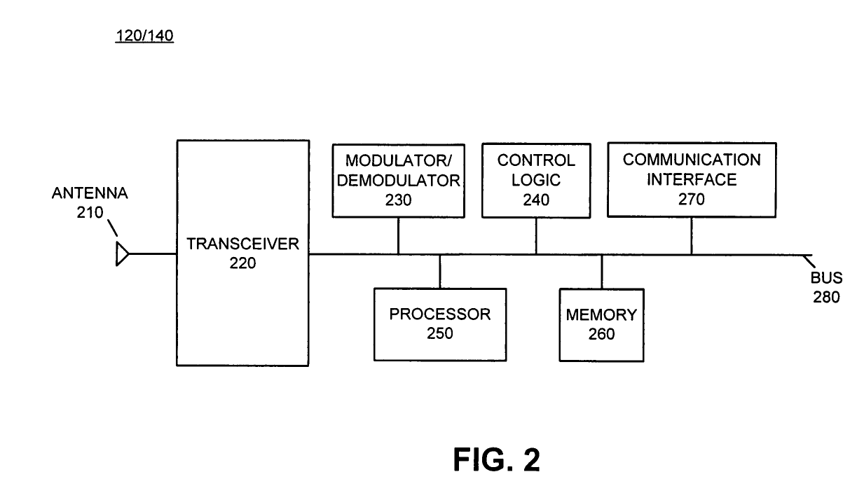

FIG. 2 illustrates an exemplary configuration of hub 120 consistent with the present invention. Referring to FIG. 2, hub 120 includes antenna 210, transceiver 220, modulator/demodulator 230, control logic 240, processor 250, memory 260, communication interface 270 and bus 280.

Antenna 210 may include one or more conventional antennas capable of transmitting/receiving radio frequency (RF) signals. Transceiver 220 may include well-known transmitter and receiver circuitry for transmitting and/or receiving RF data in a network, such as network 100. Modulator/demodulator 230 may include conventional circuitry that combines data signals with carrier signals via modulation and extracts data signals from carrier signals via demodulation. Modulator/demodulator 230 may also include conventional components that convert analog signals to digital signals, and vice versa, for communicating with other devices in hub 120.

Control logic 240 may include one or more logic devices, such as application specific integrated circuits (ASICs), field programmable gate arrays (FPGAs), etc., that control the operation of hub 120. Processor 250 may include one or more conventional processors or microprocessors that interprets and executes instructions.

Memory 260 may provide permanent, semi-permanent, or temporary working storage of data and instructions for use by processor 250 in performing processing functions. Memory 260 may include a conventional random access memory (RAM) or another dynamic storage device that stores information and instructions for execution by processor 250. Memory 260 may also include a conventional read only memory (ROM), an electrically erasable programmable read only memory (EEPROM) or another static or non-volatile storage device that stores instructions and information for use by processor 250. Memory 260 may further include a large-capacity storage device, such as a magnetic and/or optical recording medium and its corresponding drive.

Communication interface 270 may include an interface that allows hub 120 to be coupled to an external network or device. For example, communication interface 270 may include a connection to one or more broadcast entities, such as a television broadcaster. The connection to the television broadcast entity may be provided via backend systems 130.

Bus 280 may include one or more conventional buses that interconnect the various components of hub 120 to permit the components to communicate with one another. The configuration of hub 120 shown in FIG. 2 is provided for illustrative purposes only. One skilled in the art will recognize that other configurations may be employed. Moreover, one skilled in the art will appreciate that hub 120 may include other devices that aid in the reception, transmission, or processing of data.

Hub 120, consistent with the invention, performs processing associated with transmitting data to terminals 140 via satellite 110. Hub 120 may perform such processing, described in detail below, in response to processor 250 executing sequences of instructions contained in a computer-readable medium, such as memory 260. It should be understood that a computer-readable medium may include one or more memory devices and/or carrier waves. The instructions may be read into memory 260 from another computer-readable medium or from a separate device via communication interface 270. Execution of the sequences of instructions contained in memory 260 causes processor 250 to perform the process steps that will be described hereafter. In alternative embodiments, hard-wired circuitry may be used in place of or in combination with software instructions to implement the present invention. For example, control logic 240 and/or modulator/demodulator 230 may perform one or more of the processes described below. In still other alternatives, various acts may be performed manually, without the use of hub 120. Thus, the present invention is not limited to any specific combination of hardware circuitry and software.

Terminal 140 may be configured in a manner similar to hub 120. That is, terminal 140 may include an antenna 210, a transceiver 220, a modulator/demodulator 230, control logic 240, processor 250, memory 260, communication interface 270 and bus 280. Terminal 140, however, may include a number of different devices/systems than hub 120.

For example, with respect to terminal 140, communication interface 270 may include a coaxial connector/interface for communicating with a set top box used to decode and distribute television signals. Communication interface 270 may also include other types of wired or wireless interfaces for communicating with a set top box and/or television set. Communication interface 270 may also include an Ethernet interface for communicating to a local area network (LAN), an asynchronous transfer mode (ATM) network interface and/or an interface to a cable network. Alternatively, communication interface 270 may include other mechanisms for communicating with other devices and/or systems.

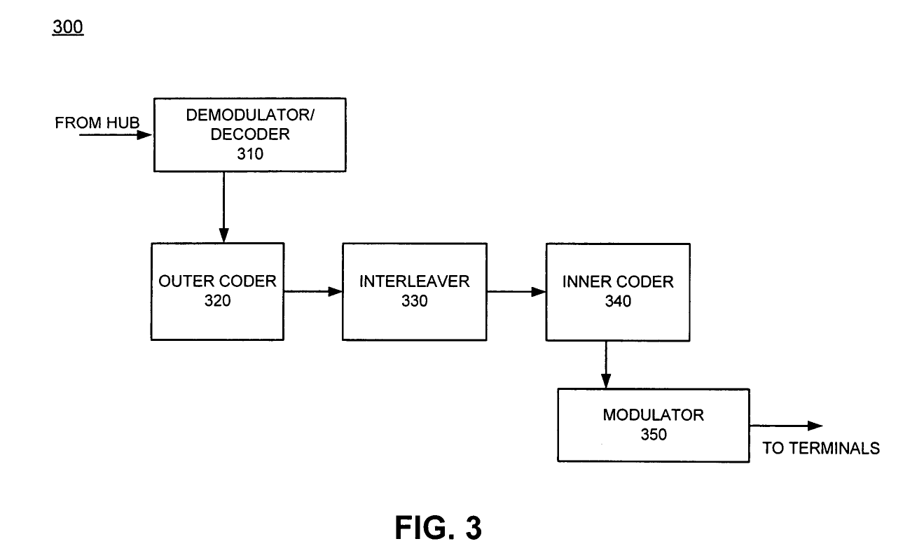

As described above, satellite 110 may include onboard processing systems that generate error correction codes to be added to received data for transmission via downlink signals. FIG. 3 is a functional block diagram illustrating an exemplary onboard processing system implemented in satellite 110 consistent with the invention. Referring to system 3, system 300 includes demodulator/decoder 310, outer coder 320, interleaver 330, inner coder 340 and modulator 350. It should be understood that system 300 may include other devices/systems that aid in the reception and transmission of data.

Demodulator/decoder 310 demodulates uplink signals received from hub 120 (or other devices/systems) and decodes the payload data transmitted via the uplink signals. Outer coder 320 receives the decoded data and generates an error correction code for the payload data. For example, in one implementation, outer coder 320 may generate a Reed-Solomon code to be transmitted with the payload data.

Interleaver 330 may reorder the bits output from outer coder 320 to randomize the data. Inner coder 340 may receive the interleaved data from interleaver 330 and generate another error correction code. For example, in one implementation, inner coder 340 may generate a convolutional code for transmission with the payload data. Modulator 350 may received the data and error correction codes from inner coder 340, remodulate the data and transmit the data as a downlink signal to terminals 140.

As described previously, the elements in system 300 are difficult if not impossible to modify once satellite 110 is launched. Therefore, enhancements to coding/decoding performed by either hub 120 or terminals 140 should be transparent to the operation of system 300. For example, in one implementation, system 300 process data on a byte-basis. Therefore, any modifications to coding performed by hub 120 must take this into account when coding uplink data for transmission to satellite 110.

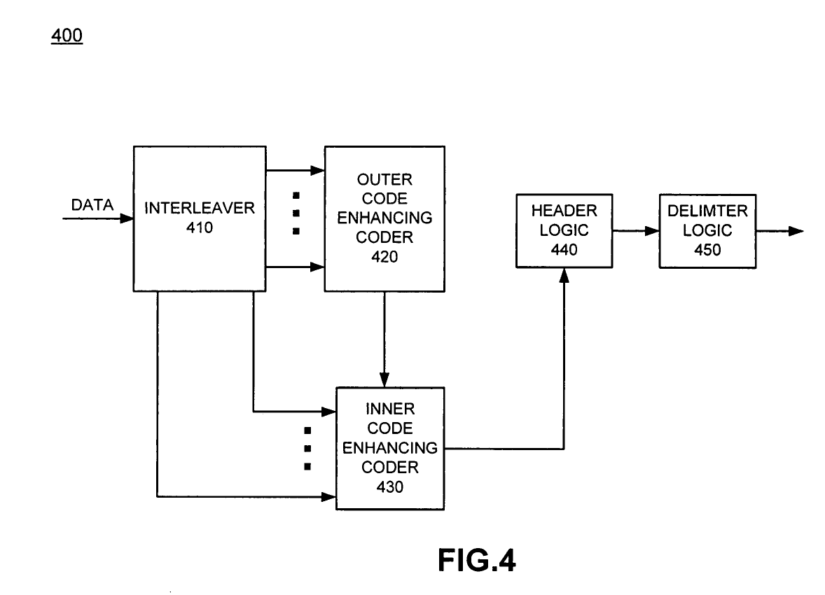

FIG. 4 illustrates an exemplary system implemented at hub 120 to enhance the coding performed by system 300. Referring to FIG. 4, system 400 includes interleaver 410, outer code enhancing coder (OCEC) 420, inner code enhancing coder (ICEC) 430, header logic 440 and delimiter logic 450. System 400 may be implemented in control logic 240 and/or by processor 250 executing instructions stored in memory 260 and/or by other devices in hub 120.

Referring to FIG. 4, interleaver 410 may be an N:1 interleaver that operates on a data stream to randomize the data in the data stream. In an exemplary implementation, interleaver 410 may be a 12:1 packet interleaver that randomizes the incoming data into 12 data streams, where each of the 12 data streams receive data in packet-sized increments. Interleaving the data into a number of separate streams may remove any correlation between a number of data packets in a burst of data packets and randomize errors that may be introduced. Interleaver 410 outputs the interleaved data streams to OCEC 420 and ICEC 430.

OCEC 420, as described in more detail below, operates to enhance the error correction capability associated with outer coder 320 onboard satellite 110 (FIG. 3). For example, OCEC 420 may enhance the error correction capability as delivered by the outer code. ICEC 430, as described in more detail below, operates to enhance the error correction capability associated with onboard inner coder 340. For example, ICEC 430 may append one or more parity bits to each byte of payload data such that a decoder at terminal 140 may be provided with increased ability to correct for errors.

Header logic 440 may append a header to each packet of data. In one implementation, header logic 440 may append a header to every 100 bytes of payload data and the header may be eight bytes in length. In this case, the packets transmitted via uplink signals may be 108 bytes in length. Header logic 440 may output the data packets to delimiter logic 450.

Delimiter logic 450 may append a delimiter to each predetermined number of data packets. In one implementation, delimiter logic 450 may append a delimiter after every 101 packets to allow a receiver, such as terminal 140, to identify the end of a particular group of packets. In other implementations, a delimiter may not be required. The number of bytes in each packet and the number of packets separated by a delimiter may be predetermined based on the processing performed by system 300. In other words, system 300 is preconfigured to operate on uplink data in a certain manner (i.e., recognize which bytes represent payload data, header data, etc.). Therefore, hub 120, satellite 110 and terminals 140 are all coordinated such that the uplink/downlink data is processed properly.

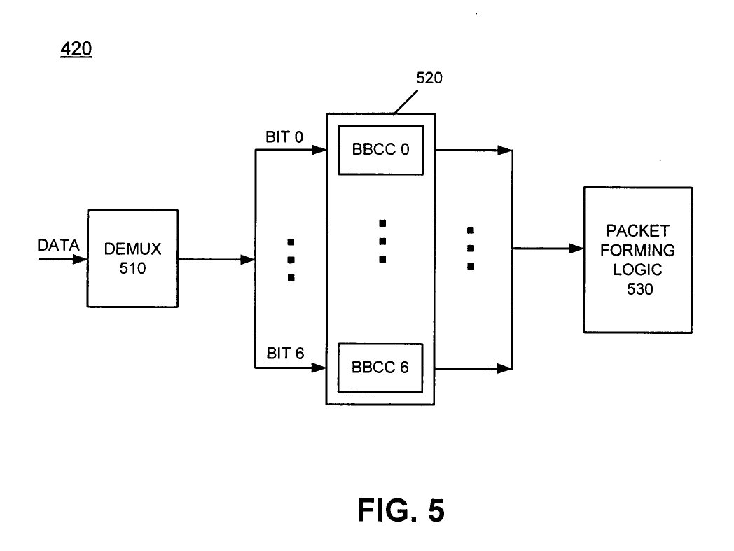

FIG. 5 is an exemplary functional block diagram illustrating a portion of OCEC 420 in an implementation consistent with the invention. Referring to FIG. 5, OCEC 420 includes demultiplexer 510, block burst correction coder (BBCC) 520 and packet forming logic 530. OCEC 420 may include similar elements for processing each data stream output from interleaver 410. In an exemplary implementation, demultiplexer 510 may be a 1:7 demultiplexer that receives an input data stream output from interleaver 410 and outputs seven separate bit streams. Each of the seven bit streams may receive one of bits 0-6 included in each byte of each data packet received by demultiplexer 510. The last bit of each byte of input data (i.e., bit 7) will not be acted upon by BBCC 520 since the last bit in each byte of uplink data will be a parity bit generated by ICEC 430, as described in more detail below.

BBCC 520, consistent with the invention, is a bit oriented coder and includes a separate BBCC coder for each bit of input data, as illustrated in FIG. 5. It should be understood that BBCC-type coders and decoders similar to that described below are known in the art of error correction. However, such coders/decoders are not used to provide error correction in the art of data communications, such as communications involving transmitting data via RF signals over air interfaces.

Referring back to FIG. 5, BBCC 520 includes BBCC 0 through BBCC 6 with each BBCC receiving a single bit of data. BBCC 0 may receive the first bit (e.g., bit 0) in each byte of data received by demultiplexer 510 and BBCC 6 may receive the seventh bit (e.g., bit 6) of each byte of data received by demultiplexer 510. Each BBCC may output a single bit of data, as described in more detail below, to packet forming logic 530.

Packet forming logic 530 may assemble the data bits output from BBCC 520 into a number of data packets. In an exemplary implementation, packet forming logic 530 may receive 100 bits of data for each 97 packets of input data received by BBCC 520 and append these 100 bits with a similar number of bits from each of BBCCs 1-6. In other words, packet forming logic 530 receives 700 bits of data for each 97 packets of input data received by demultiplexer 510.

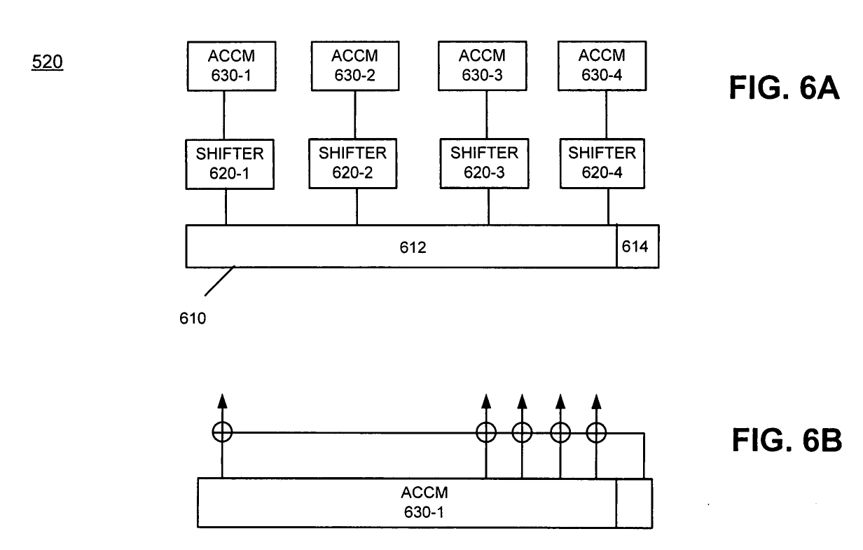

FIG. 6A illustrates a more detailed block diagram of a portion of each BBCC in BBCC 520, such as BBCC 0. Referring to FIG. 6A, BBCC 0 includes data block 610, shifters 620-1 through 620-4 (collectively referred to as shifters 620) and accumulators (ACCMs) 630-1 through 630-4 (collectively referred to as accumulators 630). Data block 610 may include fields 612 and 614. Field 612 may represent a predetermined number of bits of payload data, such as 100 bits of payload data. The 100 bits may represent bit 0 from each bit in a 100 byte packet. Field 614 may represent a single bit of data (e.g., the 101^{st} bit). In an exemplary implementation, the value of field 614 may be, for example, zero. The particular number of bits in fields 612 and 614 are based on generating four parity check blocks for every 97 packets of data, with each packet including 100 bytes of payload data.

Each block of data received by data block 610 may be assigned an index value based on the particular packet of data with which it is affiliated. For example, the first 100 bits stored in data block 610 may be affiliated with a first of 97 data packets. In this case, the index value “i” may be zero. The 97^{th} group of 100 bits stored in data block 610 may be affiliated with the 97^{th} data packet and in this case, i may equal 96. The index value i may be used to determine the amount of shifting performed by shifters 620.

Shifters 620-1 through 620-4 may be cyclic shifters that operate to shift the data in data block 610 by the sum of index value i times j, where j=1, 2, 3 or 4. For example, for shifter 620-1, j=1. In this manner, shifters 620 shift the data in block 610 by different values. For example, if i=5 and j=1, shifter 620-1 may cyclically shift data in block 610 by five bit positions. Shifter 620-2 may shift the data in block 610 by ten bit positions, etc. In this manner, each shifter 620 shifts the data in block 610 by different amounts. The cyclic shifting performed by shifters 620 may be either a left cyclic shift or a right cyclic shift.

The shifted data may then be output to accumulators 630-1 through 630-4, as illustrated in FIG. 6A. The value in field 614 (e.g., bit 100) of each accumulator 630 may then be binary summed with the values in each of bit positions 0-99 of accumulator 630 in a bit-wise fashion. For example, FIG. 6B illustrates an example associated with the binary summing. Referring to FIG. 6B, the 101^{st} bit position of an accumulator, such as ACCM 630-1, may be binary summed with each of the other 100 bits stored in accumulator 630-1 The output of each accumulator 630 may then be output to packet forming logic 530 (FIG. 5). In this manner, accumulators 630-1 through 630-4 each output 100 bits of data for every 97 packets input to BBCC 520. Each other BBCC in BBCC 520 similarly outputs the same amount of data (e.g., four 100 bit blocks). Packet forming logic 530 may then form four packets of redundant data, with each packet include 700 bits of data. The eighth bit in each byte will be a parity check bit generated by ICEC 430, as described in more detail below.

Referring back to FIG. 4, ICEC 430 also receives the same input bit stream as OCEC 420. ICEC 430, consistent with the invention, generates a parity bit for each seven bits of data in each input data stream. In other implementations, ICEC 430 may generate a parity bit for other amounts of data, such as every three bits of data, based on the particular user requirements. In each case, ICEC 430 is configured to operate in accordance with processing performed by onboard system 300 so that system 300 may perform its processing in a transparent manner with respect to the operations performed by ICEC 430.

ICEC 430 also receives the output of OCEC 420 and generates a parity bit for each seven bits of data. In this manner, the 700 bits of data in each packet output from OCEC 420 are converted into 100 byte packets having eight bits per byte, where the eighth bit of each byte is a parity bit. In an exemplary implementation, ICEC 430 is configured to generate the parity bit using an even parity scheme. Header logic 440 may then append a header to each 100 bytes of data and delimiter logic 450 may append a delimiter for every predetermined number of packets, such as every 101 packets. The delimiter may allow satellite 110 and terminal 140 to identify the end of a group of 101 packets. In other implementations, a delimiter may not be needed.

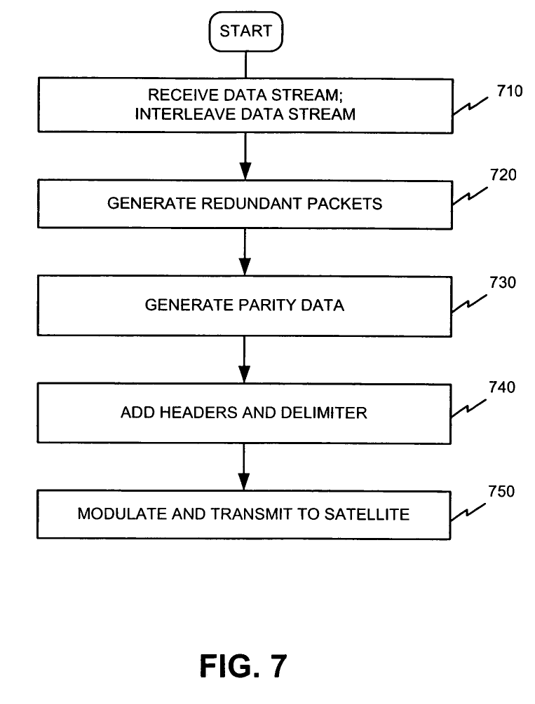

FIG. 7 illustrates exemplary processing associated with transmitting uplink data to satellite 110, consistent with the invention. Assume that hub 120 and terminals 140 have already started up and performed an initialization procedure, i.e., performed timing synchronization, power control, etc. Further assume that hub 120 receives a data stream for broadcast to terminals 140 (act 710). The data stream may represent video data to be broadcast to terminals 140.

As discussed above with respect to FIG. 4, hub 120 provides enhanced coding to supplement the coding performed by onboard system 300. For example, the input data stream is received by interleaver 410, which interleaves the data and forwards the interleaved data to OCEC 420 and ICEC 430 (act 710). OCEC 420, as described above with respect to FIGS. 5, 6A and 6B, may then generate a number of redundant data packets for each predetermined number of input data packets (act 720). OCEC 420 may output the redundant packets to ICEC 430.

ICEC 430 may generate a parity bit for each predetermined number of input bits (e.g., seven) of received data (act 730). For example, ICEC 430 receives the data streams from interleaver 410, generates a parity bit for each predetermined number of bits in each stream and inserts the parity bit in the last bit of each byte of the received data streams. ICEC 430 may also generate a parity bit for each predetermined number of bits received from OCEC 420 and insert the parity bit in the last bit in each byte of each of the four packets received from OCEC 420. ICEC 430 may then attach the four redundant packets received from ICEC (with the parity information added) to the end of a group of 97 packets received from interleaver 410 (with the parity information added) and forward the packets to header logic 440.

Header logic 440 may append a header to each predetermined number of bytes of data, such as each 100 bytes (act 740). The size of the header may be, for example, eight bytes in length. Header logic 440 may forward the data to delimiter logic 450, which may insert a delimiter to separate each predetermined number of data packets (act 740). As discussed previously, in some implementations, a delimiter may not be needed. Delimiter logic 450 may then forward the data to uplink processing for modulation and transmission to satellite 110 (act 750).

Satellite 110 may receive the uplink signal, demodulate the signal and decode the data. As discussed previously, system 300 operates in accordance with its preset procedure, even though hub 120 has modified its coding to provide enhanced error correction capabilities. In other words, the additional coding performed by hub 120 is transparent with respect to system 300.

Satellite 110 may then re-encode the data, re-modulate the data and transmit the data via a downlink signal to terminals 140, as discussed above with respect to FIG. 3. Terminals 140 may receive the downlink data, demodulate/decode the received data, as described in more detail below.

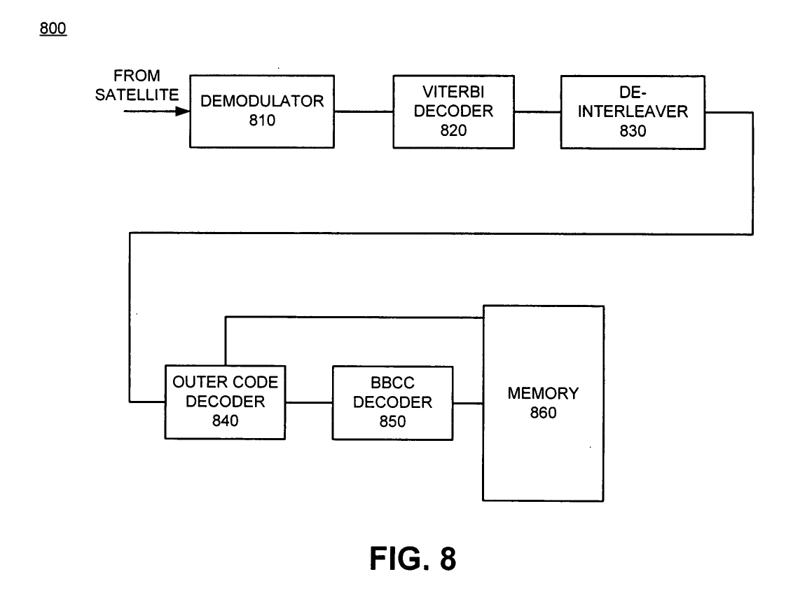

For example, FIG. 8 is a block diagram of an exemplary system implemented in terminal 140 consistent with the invention. Referring to FIG. 8, system 800 includes demodulator 810, Viterbi decoder 820, de-interleaver 830, outer code decoder 840, BBCC decoder 850 and memory 860. The elements illustrated in FIG. 8, may be implemented by hard-wired logic (e.g., modulator/demodulator 230 and/or control logic 240, FIG. 2) and/or by processor 250 executing instructions stored in memory 260. Terminal 140 may also include an antenna and receiver circuitry, as discussed above with respect to FIG. 2.

Demodulator 810 receives the downlink signal from the receiver/transceiver (not shown), demodulates the downlink data and forwards the demodulated data to Viterbi decoder 820. Viterbi decoder 820, as is understood in this art, may perform a soft decoding that includes add, compare, select (ACS) operations, survivor path update operations and traceback operations to decode the demodulated downlink data. In addition to these conventional operations, Viterbi decoder 820 may include a bank of registers used to decode the data.

In an exemplary implementation, the bank of registers may be the size of the number of trellis states of the convolutional code used by inner coder 340. That is, the number of registers may have a one-to-one correspondence with the trellis states. Each of the registers may store one binary value to represent the current accumulated parity of the surviving path. The registers may each be set to zero at the beginning of each ICEC codeword (i.e., byte boundary).

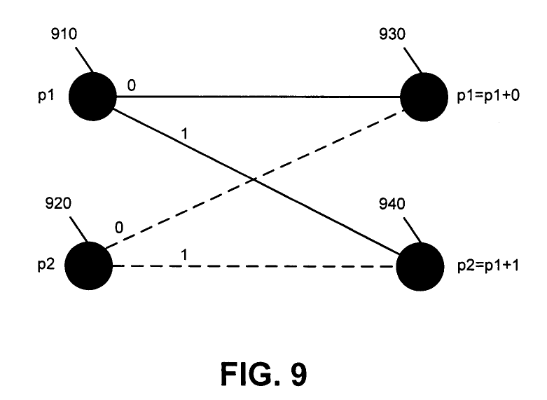

FIG. 9 illustrates an example of how the registers in Viterbi decoder 820 may be updated. Referring to FIG. 9, a two-state trellis is illustrated for simplicity, where the solid lines represent survivor paths. In the example in FIG. 9, it is assumed that the contents of the registers corresponding to the current survivor path are p1 and p2, respectively, as indicated by nodes 910 and 920. At the next trellis section, assuming that the surviving path on node 910 is from the first node of a previous epoch with a zero input, then node 910 is updated as p1_new=p1_old+0, as indicated by node 930. If, at the second node (i.e., node 920), the surviving path also comes from the first node of the previous epoch with an input of 1, node 920 is updated as p2_new=p1_old+1, as indicated by node 940. In this case, the summation is a binary summation.

When Viterbi decoder 820 reaches the end of one ICEC codeword (i.e., at a byte boundary in one embodiment), the metric of the surviving path for the nodes with odd parity is set to the minimum number in the quantization system. In this manner, the surviving path with odd parity will be effectively excluded from further expansion (in situations in which the parity generated by ICEC 430 is set to even parity). The above described decoding performed by Viterbi decoder 820 provides good decoding results in an efficient manner. It should be understood that other decoding schemes may be implemented by Viterbi decoder 820 based on the particular system requirements.

De-interleaver 830 may de-interleave the received data output from Viterbi decoder 820. Outer code decoder 840 may then decode the outer code generated by onboard system 300. For example, as described above with respect to FIG. 3, the outer code generated by outer coder 320 may be a Reed-Solomon code. In this case, outer code decoder 840 performs Reed-Solomon decoding. If the Reed-Solomon decoder 840 indicates that an error occurred during decoding, the packet containing the error may be marked as an “erased” packet and passed to BBCC decoder 850. If no error occurs, the data packet may be passed to memory 860 for forwarding to an end user device, such as a set top box. BBCC decoder 850 may act as an erasure correction decoder, as described in more detail below.

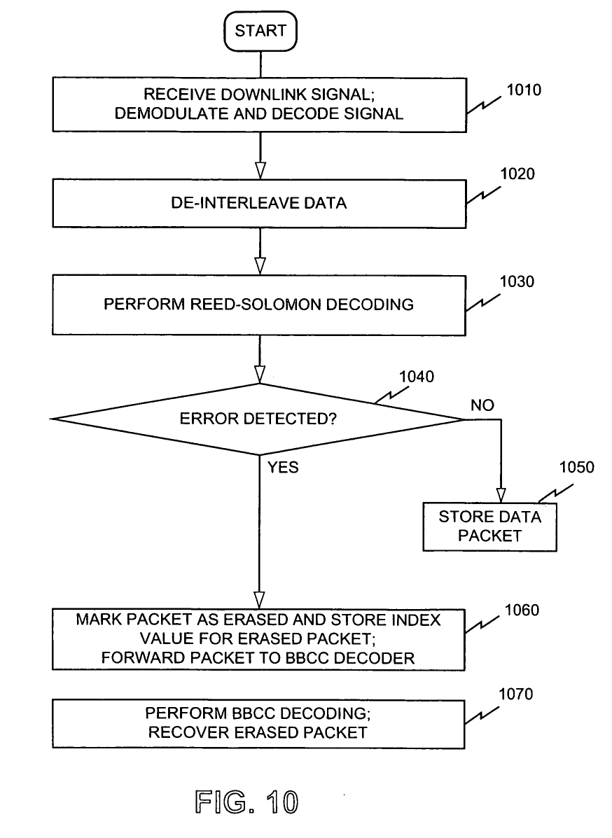

FIG. 10 illustrates exemplary processing associated with processing downlink data. Processing may begin with terminal 140 receiving a downlink signal (act 1010). Demodulator 810 may demodulate the downlink signal and forward the demodulated data to Viterbi decoder 820. Viterbi decoder 820 may decode the demodulated data as discussed above with respect to FIGS. 8 and 9 and forward the decoded data to de-interleaver 830 (act 1010).

De-interleaver 830 may de-interleave the data in accordance with the interleaving scheme used by interleaver 330 in onboard system 300 and forward the de-interleaved data to outer code decoder 840 (act 1020). The outer code decoder 840 may perform its decoding on a packet basis to determine whether any errors occurred in each packet.

For example, as discussed above, outer coder decoder 840 may perform a Reed-Solomon decoding (act 1030). If the outer code decoder 840 indicates that the data packet passed the decoding, outer code decoder 840 forwards the data packet to memory 860 for temporary buffering before passing the data packet to its destination (acts 1040 and 1050). The data in memory 860 may be forwarded to the destination device with the other packets in the received data stream. Processing may continue with the next packet.

If outer code decoder 840 detects an error in a packet, outer code decoder 840 marks the packet as erased, stores an index value identifying the particular packet and forwards the data packet to BBCC decoder 850 (acts 1050 and 1060). BBCC decoder 850 may then perform an “erasure correction” operation to recover the erased packet (act 1070).

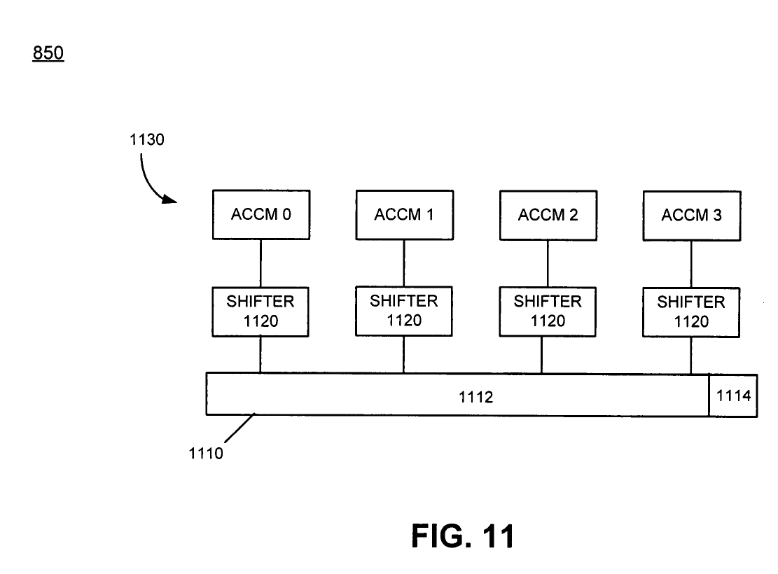

For example, FIG. 11 illustrates an exemplary block diagram of BBCC decoder 850, consistent with the invention. Referring to FIG. 11, BBCC decoder 850 may include data block 1110, shifters 1120 and accumulators (ACCMs) 1130. BBCC decoder 850, consistent with the invention, may operate over 101 packets, with the last four packets representing the redundant packets generated by OCEC 420. That is, BBCC decoder 850 is configured to perform the reverse operation as BBCC coder 520 and is configured to recognize how many packets are payload packets and how many packets are redundant packets.

Block 1110 may include fields 1112 and 1114 that correspond to fields 612 and 614 used by BBCC 520. That is, field 1112 may store 100 bits of a data packet and field 1114 may store a 101^{st} bit, which may be a zero. BBCC decoder 850 may initialize the values in accumulators 1130 as all zeroes. After the values in accumulators 1130 are initialized, for a non-erased received packet, the packet is loaded into 1112 and then is shifted by shifters 1120. The amount of shifting depends on the index of the received packet and the particular shifter (e.g., similar to the shifting described above with respect to shifters 620). The shifted value will be accumulated into ACCMs 1130. Once an erased packet is indicated, the index of the packet is recorded for further processing.

At the end of each coded group of packets, the number of erased packets is known and for simplicity, r, may be used to denote the number of erased packets. The decoding process may be formally described as follows.

The 100 bits input from the i-th packet to the BBCC decoder (e.g., BBCC 0) may be expressed in terms of a polynomial as:
Vi(x)=vᵢ₀+vᵢ₁x+vᵢ₂x²+ . . . +vᵢ₉₉x⁹⁹

Initialization: Assume that there are r syndrome accumulators S[0], S[1], . . . , S[r−1], and r output packet accumulators y[0], y[1], . . . , y[r−1] in each BBCC decoder (e.g., BBCC0-BBCC6). Each accumulator may be 101 bits in size and all accumulators may be initialized to 0, as discussed above.

For each correctly received packet with index i, the 101 bits (100 info bits plus one 0 bit) may be cyclically right shifted by the sum of i*j bits and added to syndrome S[j], i.e.,
S[j]=S[j]+Vi(x)x^{ij}, j=0, 1, . . . , r−1,
At the end of this step,
S[0]=V₀(x)+V₁(x)+ . . . +Vᵢ(x)+ . . .
S[1]=V₀(x)+V₁(x)x+ . . . +Vᵢ(x)xⁱ+ . . .
. . .
S[r−1]=V₀(x)+V₁(x)x^{r-1}+ . . . +Vᵢ(x)x^{(r-1)i}+ . . .

After finding the indices (Idx[k]) of the erased packets, i.e., Idx[k] k=0,1, . . . , r−1, for each k, starting with j=r−1, S[j−1] may be cyclically right shifted by Idx[k] bits and added to S[j], i.e.,
S[j]=S[j]+S[j−1]*x^{Idx[k],} j=r−1, . . . ,1; k=0,1, . . . , r−1

Next, to generate the erased packets for k=0, 1, . . . , r−1, the output packet accumulator y[0], y[1], . . . , y[r−1] may be initialized with S[0]. Then for each k, starting with j=1, y[k] may be cyclically right shifted by Idx[k] bits and S[j] may be added to y[k], for j=1, . . . , r−1, i.e.,
y[k]=y[k]*x^{Idx[k]}+S[j], j=1, . . . , r−1; k=0,1, . . . , r−1

For each k=0,1, . . . , r−1, the size of y[k] may be reduced to 100 bits by XORing the 101^{st} bit with every other bit and getting rid of the 101^{st} bit after the XORing. Then, starting with j=0, y[k] may be calculated as follows.
y[k]=y[k]/(x^{Idx[k]}+x^{Idx[k]}) for j=0,1, . . . , r−1, and j≠k; k=0,1, . . . , r−1
The final result in y[k] (100 bits) yields the k-th erased block with index Idx[k].

It should be understood that if the number of packets indicated as erased within a group of packets is above a predetermined number, BBCC decoder 850 may be unable to recover the erased packets. In this case, system 800 may indicate that a decoding failure occurred. The particular number of erased packets within a group of packets that results in the decoding failure may be based on the number of redundant data packets transmitted with the group of payload packets.

Systems and methods consistent with the invention enhance error correction capabilities of a receiving device. The enhanced error correction may be transparent with respect to processing performed by a distribution device.

The foregoing description of preferred embodiments of the present invention provides illustration and description, but is not intended to be exhaustive or to limit the invention to the precise form disclosed. Modifications and variations are possible in light of the above teachings or may be acquired from practice of the invention. For example, while series of acts have been described with respect to FIGS. 7 and 10, the order of the acts may be modified in other implementations consistent with the present invention. Moreover, non-dependent acts may be performed in parallel.

In addition, the present invention has been described mainly with respect to broadcasting video data from a hub to a number of ground stations via a satellite. It should be understood that the techniques described herein are also applicable to any data transmission system or scheme, such as a terrestrial data distribution scheme. In addition, the techniques may also be used with transmitting other types of data, such as non-video based data streams.

No element, act, or instruction used in the description of the present application should be construed as critical or essential to the invention unless explicitly described as such. Also, as used herein, the article “a” is intended to include one or more items. Where only one item is intended, the term “one” or similar language is used.

1. A system, comprising:
a first coder configured to receive at least one first data stream, and generate a plurality of data packets based on the received at least one first data stream, the plurality of data packets representing redundant data packets;
a second coder configured to receive the at least one first data stream and the redundant data packets, generate parity information for the received at least one first data stream and the redundant data packets, and output a second data stream comprising the at least one first data stream, the plurality of redundant packets and the parity information; and
logic configured to modulate the second data stream, and forward the modulated data.

2. The system of claim 1, further comprising:
a transmitter configured to receive the modulated data, and transmit the modulated data to a satellite.

3. The system of claim 1, wherein the first coder is configured to generate a first number of redundant data packets for each second number of payload data packets.

4. The system of claim 3, wherein the first number is four and the second number is 97.

5. The system of claim 1, further comprising:
an interleaver configured to receive video input data and output the at least one first data stream.

6. The system of claim 5, wherein the at least one first data stream comprises 12 data streams.

7. The system of claim 1, wherein the first coder comprises a plurality of coders, each of the plurality of coders configured to process a same bit in each received byte of the at least one first data stream.

8. The system of claim 7, wherein each of the plurality of coders comprises:
a buffer configured to store a block of data, the block of data representing the same bit in each byte of a data packet, and
logic configured to cyclically shift the contents of the buffer based on an index associated with the stored block of data, binary sum a first bit of the buffer with each other bit in the buffer, and output a plurality of bits based on the binary summing.

9. A device for processing data, comprising:
a receiver configured to receive video data, the video data including a payload portion including parity information and a redundant data portion;
a demodulator coupled to the receiver, the demodulator configured to demodulate the received video data;
a first decoder configured to decode the received data using a soft decoding process;
a second decoder configured to determine whether the payload portion contains an error; and
a third decoder configured to perform an error recovery procedure on the payload portion when the second decoder indicates that the payload portion contains an error.

10. The device of claim 9, wherein the receiver is configured to receive the video data over a wireless interface.

11. The device of claim 9, wherein the receiver is configured to receive the video data from a satellite.

12. The device of claim 9, wherein the soft decoding process comprises a Viterbi decoding process.

13. The device of claim 9, further comprising:
a deinterleaver configured to de-interleave data output from the first decoder and forward the de-interleaved data to the second decoder.

14. The device of claim 13, wherein the second decoder comprises a Reed-Solomon decoder, the Reed-Solomon decoder configured to decode each packet of data in the payload portion, and identify an error in a first packet included in the payload portion.

15. The device of claim 14, wherein the Reed-Solomon decoder is further configured to identify an index value associated with the first packet.

16. The device of claim 9, wherein the third decoder comprises:
a plurality of decoders, each of the plurality of decoders configured to process a block of data bits associated with the redundant data portion, and perform a cyclic shifting of the block of data bits based on an index of the erroneous packet.

17. The device of claim 16, wherein each of the plurality of decoders is further configured to perform a binary summing operation after the cyclic shifting.

18. A system for transmitting video data, comprising:
means for receiving a first data stream;
means for generating a plurality of redundant data packets based on the first data stream;
means for generating parity information for the first data stream and the redundant data packets;
means for forming data packets comprising the first data stream, the redundant data packets and the parity information;
means for modulating the data packets; and
means for transmitting the modulated data packets.

19. The system of claim 18, further comprising:
means for receiving the modulated data packets;
means for demodulating and decoding the modulated data packets;
means for re-encoding the decoded data packets; and
means for transmitting the re-encoded data packets.

20. The system of claim 19, further comprising:
means for receiving the re-encoded data packets;
means for decoding the re-encoded data packets;
means for determining that an error occurred in a first data packet;
means for generating an index value associated with the first data packet; and
means for recovering the first data packet using the index value.

21. A method for distributing data via radio frequency (RF) signals, comprising:
receiving a plurality of data packets;
generating parity information for each of the plurality of data packets;
generating a plurality of redundant packets based on the received data packets; and
forwarding the plurality of data packets, the parity information and the redundant data packets to a distribution device via RF signals.

22. The method of claim 21, further comprising:
receiving, at the distribution device, the RF signals;
demodulating the RF signals;
decoding the demodulated RF signals to obtain decoded data;
re-encoding the data using at least two coding schemes; and
broadcasting the re-encoded data to a plurality of locations.

23. The method of claim 22, wherein the distribution device comprises a satellite and the plurality of redundant data packets increase an error correction capability at the plurality of locations.

24. The method of claim 21, wherein the redundant packets are processed by the distribution device in a same manner as the plurality of data packets.

25. A device configured to process data, comprising:
a receiver configured to receive data transmitted via a modulation scheme over an air interface; and
at least one logic device configured to demodulate the received data, perform a first decoding of the data, de-interleave the decoded data, perform a second decoding of the data, determine whether an error occurred based on the second decoding, and perform an error recovery operation when an error occurred, the error recovery procedure including a cyclic shifting operation.

26. The device of claim 25, wherein when performing the cyclic shifting, the at least one logic device is configured to cyclically shift a first predetermined number of bits by a number of bit positions based on an index value associated with a packet containing an error.

27. A device configured to receive data packets transmitted over an air interface, the device comprising:
a first decoder configured to decode the received data packets using a soft decoding procedure;
a second decoder configured to detect data packets with errors, identify a first data packet with an error as an erased packet, and assign an index value to the erased packet; and
a third decoder configured to recover the erased packet using the assigned index value and data packets successfully decoded by the first and second decoders.

28. The device of claim 27, wherein the data packets are transmitted in a payload portion of a data frame.

29. The device of claim 27, wherein the third decoder is configured to determine whether a number of data packets identified as erased packets within a group of data packets is less than a predetermined value, and recover the data packets identified as erased packets when the number of data packets identified as erased packets is less than the predetermined value.

30. The device of claim 29, wherein the third decoder is further configured to determine that a decoding failure occurred when the number of data packets identified as erased packets is more than the predetermined value.

31. The device of claim 29, wherein the group of data packets is identified based on delimiters included with the received data packets.

32. A device for decoding data, comprising:
a receiver for receiving a data stream;
a plurality of registers, each register corresponding to a surviving path associated with a plurality of trellis states; and
logic configured to reset contents of the plurality of registers to zero at a beginning of a boundary, update the contents of the plurality of registers based on a parity of the surviving path, and eliminate the surviving path with odd accumulated parity at an end of the boundary.

33. The device of claim 32, wherein the data stream represents an even parity data stream and the beginning of a boundary corresponds to the beginning of a byte of data.

34. The device of claim 33, wherein when eliminating the surviving path, the logic is configured to eliminate the surviving path at the end of the byte of data.

35. The device of claim 32, wherein when eliminating the surviving path, the logic is configured to set a metric of the surviving path to a minimum number.
